(19) United States
(12) Patent Application Publication
(10) Pub. No.: US 2023/0032212 A1
(43) Pub. Date: Feb. 2, 2023

(54) LOCK RING WITH BLOCKING KEYS

(71) Applicant: Hewlett-Packard Development Company, L.P., Spring, TX (US)

(72) Inventors: Julie A. Jensen, Boise, ID (US); Cameron Hutchings, Boise, ID (US)

(21) Appl. No.: 17/388,377

(22) Filed: Jul. 29, 2021

(51) Int. Cl. F16M 13/02; B41F 27/00; F16B 5/06

(52) U.S. Cl. CPC F16M 13/02; B41F 27/00; F16B 5/0607

(57) ABSTRACT

In some examples, an apparatus can include a base plate to interface with a printing device, where the base plate includes an extension member having a pawl, and a lock ring, where the lock ring includes a blocking key, where the lock ring is to interface with the base plate such that the blocking key prevents rotation of the extension member to lock the base plate to the printing device.

### BACKGROUND

Imaging/printing systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1A is an exploded perspective view of an example of an apparatus including a base plate and a lock ring consistent with the disclosure.

FIG. 1B is a perspective view of an example of an apparatus including a base plate and a lock ring interfaced with the base plate consistent with the disclosure.

FIG. 2A is an exploded perspective view of an example of an apparatus including a base plate, a lock ring, and an outer cover of a printing device consistent with the disclosure.

FIG. 2B is a perspective view of an example of an apparatus including a base plate, a lock ring interfaced with the base plate, and the base plate interfaced with an outer cover of a printing device consistent with the disclosure.

FIG. 3A is a section view of an example of a printing device including a base plate, a lock ring including snaps, and an outer cover of a printing device consistent with the disclosure.

FIG. 3B is a section view of an example of a printing device including a base plate including an extension member having a pawl, a lock ring including a blocking key, and an outer cover of a printing device consistent with the disclosure.

FIG. 3C is a zoomed section view of an example of a printing device including a base plate including an extension member having a pawl, a lock ring including a blocking key, and an outer cover of the printing device consistent with the disclosure.

### DETAILED DESCRIPTION

Imaging/printing devices may include a supply of a print material. As used herein, the term “print material” refers to a substance which can be transported through and/or utilized by an imaging device. In some examples, print material can be, for instance, a material that when applied to a medium, can form representation(s) (e.g., text, images, models, etc.) on the medium during a print job. Print material may include ink, toner, polymers, metals, colorants, etc.

The print material can be deposited onto a physical medium. As used herein, the term “printing device” refers to any hardware device with functionalities to physically produce representation(s) (e.g., text, images, models, etc.) on the medium. In some examples, a “medium” may include paper, photopolymers, plastics, composite, metal, wood, fabric, or the like. A printing device can further include other functionalities such as scanning, faxing, and/or other printing device functionalities, and can perform print jobs when in receipt of a print job request from a computing device or other network (e.g., Internet) connected device.

User inputs to a printing device may be made through various input mechanisms. For example, input mechanisms for a printing device may include utilizing buttons on the printing device, a touch screen display on the printing device, transmitting wireless signals to the printing device, among other types of input mechanisms.

In some examples, a dial control panel can be utilized as an input mechanism for a printing device. A dial control panel can include, for instance, a wheel that can be rotated (e.g., by a user) to navigate menus, select printing functions, etc. Such menus, printing functions, and other information may be displayed on a display that can be included on the printing device, integrated within the dial control panel, etc. The dial control panel can be depressed by a user in order to make a menu selection, select a print function, etc. In some examples, the user may make a selection by interacting with the display, which may be a touch screen display.

The dial control panel can allow for a more streamlined and efficient input mechanism relative to previous approaches. For example, a dial control panel may allow a user to more quickly navigate different printing device functions, input information such as number of copies (e.g., for a print job), email addresses, shared folders, usernames/passwords, etc., as compared with previous approaches.

The dial control panel can be installed in the printing device in a quick and easy way. For example, it may be beneficial to include an installation mechanism that can allow for installation without the use of tools and/or fasteners, as well as allowing installation to occur without having to access the installation location through other portions of the printing device (e.g., through a back side of an outer cover of the printing device, through other covers, etc.) Further, the installation mechanism should secure the dial control panel to the printing device in order to prevent the dial control panel from becoming unsecured when the printing device is tested (e.g., drop tested), shipped, and/or being utilized by an end user (e.g., a customer).

Lock ring with blocking keys, according to the disclosure, can allow for a printing device to utilize a base plate to interface with the printing device. The base plate can allow the dial control panel to be interfaced with the printing device without the use of tools and/or mechanical fasteners. Further, the lock ring can lock the base plate to the printing device to ensure the base plate (e.g., and the dial control panel) remain locked and/or secured to the printing device during testing, shipment, and/or during use by a customer, as is further described herein.

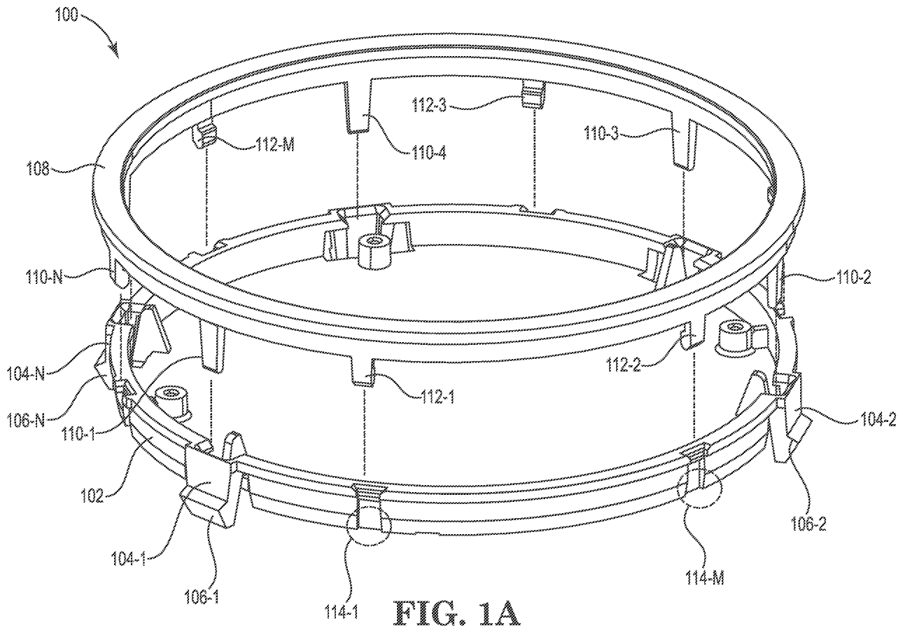

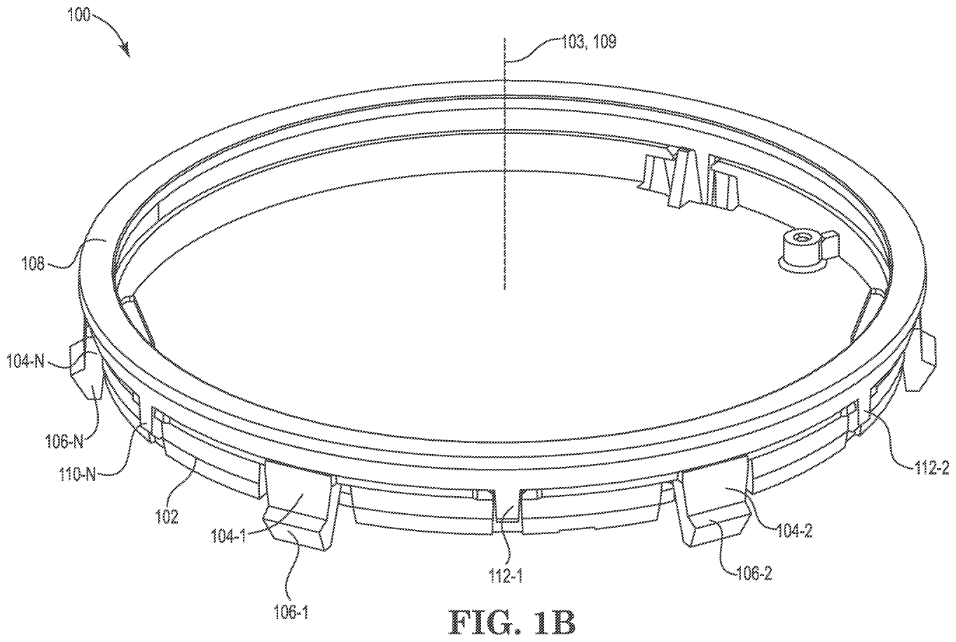

FIG. 1A is an exploded perspective view of an example of an apparatus 100 including a base plate 102 and a lock ring 108 consistent with the disclosure. As illustrated in FIG. 1A, the lock ring 108 can interface with the base plate 102.

As illustrated in FIG. 1, the apparatus 100 can include a base plate 102. As used herein, the term “base plate” refers to an object to which other objects are attached for support. For example, the base plate 102 can allow for a lock ring 108 to interface thereto to secure a dial control panel to a printing device, as is further described herein.

The base plate 102 can be a plastic material. However, examples of the disclosure are not so limited. For example, the base plate 102 can be metal, carbon fiber, and/or any other type of material. Further, the base plate 102 may be molded (e.g., by insert molding, injection molding, overmolding, or other molding techniques), three-dimensional (3D) printed, machined, or manufactured via any other manufacturing technique.

The base plate 102 can interface with a printing device. For example, the base plate 102 can be connected to a printing device. The base plate 102 can provide support for a dial control panel (e.g., not illustrated in FIG. 1A) to operate as an input mechanism for the printing device, where a user can utilize the dial control panel to navigate menus, select printing functions, etc.

The base plate 102 can include extension members 104-1, 104-2, 104-N (referred to collectively herein as extension members 104). As used herein, the term “member” refers to a constituent part of a structural whole. For example, extension members 104 can be structural members of the base plate 102. The extension members 104 can extend from the base plate 102 in a direction “downwards” and “away” from the base plate 102 as oriented in FIG. 1A.

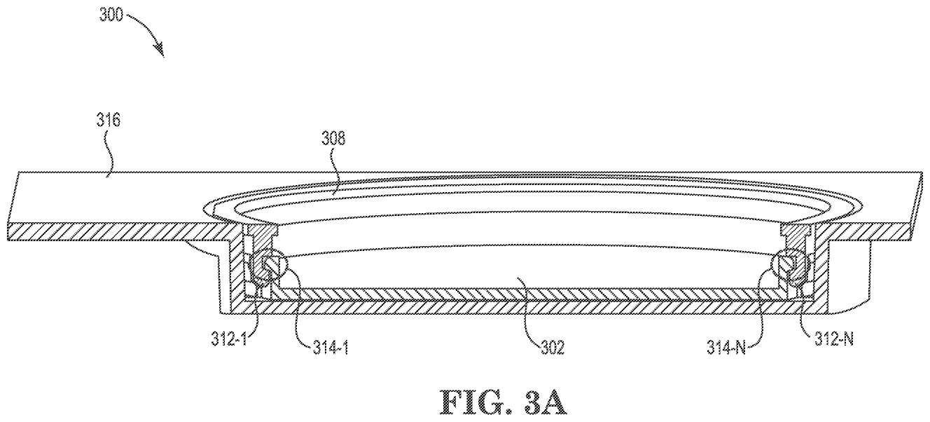

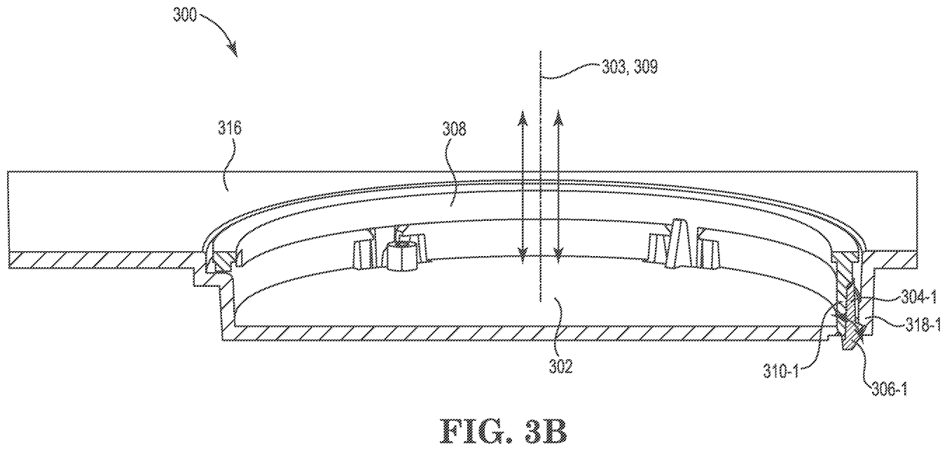

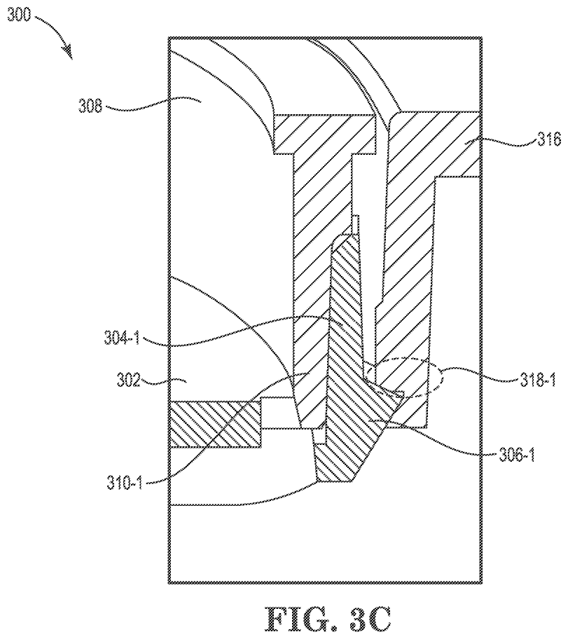

The extension members 104-1, 104-2,104-N can each include a pawl 106-1, 106-2, 106-N, respectively (referred to collectively herein as pawls 106). As used herein, the term “pawl” refers to a mechanical component that engages with another component to prevent movement of the another component. For example, the pawls 106 can engage with an undercut groove of an outer cover of the printing device, as is further described in connection with FIGS. 3B and 3C.

The extension members 104 can be radially spaced apart from a central axis 103 of the base plate 102. For example, the extension members 104 can be located radially outwards from the central axis 103 and around a perimeter of the base plate 102.

The base plate 102 can further include undercut grooves 114-1, 114-M (referred to collectively herein as undercut grooves 114). As used herein, the term “undercut groove” refers to an indentation in a surface having an overhanging edge. For example, the undercut grooves 114 can be indentations in the surface of the base plate 102 having overhanging edges utilized by snaps 112 to secure the lock ring 108 with the base plate 102, as is further described herein.

The apparatus 100 can further include a lock ring 108. As used herein, the term “lock ring” refers to device that prevents another device from moving when interfaced with the another device. For example, the lock ring 108 can prevent movement of the base plate 102 when the lock ring 108 is interfaced with the base plate 102. Although not illustrated in FIG. 1A, the dial control panel can be connected to the base plate 102. When the lock ring 108 is interfaced with the base plate 102, the lock ring 108 prevents movement of the base plate 102 (e.g., and the dial control panel) relative to the imaging device, securing the dial control panel to the printing device, as is further described herein.

The lock ring 108 can be a plastic material. However, examples of the disclosure are not so limited. For example, the lock ring 108 can be metal, carbon fiber, and/or any other type of material. Further, the lock ring 108 may be molded (e.g., by insert molding, injection molding, overmolding, or other molding techniques), three-dimensional (3D) printed, machined, or manufactured via any other manufacturing technique.

The lock ring 108 can include blocking keys 110-1, 110-2, 110-3, 110-4, 110-N (referred to collectively herein as blocking keys 110). As used herein, the term “blocking key” refers to a member that obstructs movement of another member. For example, when the lock ring 108 is interfaced with the base plate 102, the blocking keys 110 can prevent movement of the extension members 104 when the base plate experiences an upward pulling force (e.g., as oriented in FIG. 1A), as is further described in connection with FIGS. 3B and 3C.

The blocking keys 110 can be radially spaced apart from a central axis 109 of the lock ring 108. For example, the blocking keys 110 can be located radially outwards from the central axis 109 and around a perimeter of the lock ring 108.

As illustrated in FIG. 1A, the lock ring 108 can include snaps 112-1, 112-2, 112-3, 112-M (referred to collectively herein as snaps 112). As used herein, the term “snap” refers to a fastening mechanism including a protruding flange having an engagement tooth. The snaps 112 can be, for example snap clips. The snaps 112 can be deflected when an object to be secured is inserted adjacent to the snaps 112 and an engagement tooth of each of the snaps can engage with a surface of the object to secure the object. For example, the snaps 112 can include engagement teeth that can engage with the overhanging edge of the undercut grooves 114 of the base plate 102. Such engagement can interlock the lock ring 108 with the base plate 102 via a snap fit therebetween. As used herein, the term “snap fit” refers to an assembly method to attach flexible parts by pushing the parts interlocking components together. For example, the lock ring 108 can interlock with the base plate 102 via the snaps 112 and the undercut grooves 114, as described above.

The snaps 112 can be radially spaced apart from a central axis 109 of the lock ring 108. For example, the snaps 112 can be located radially outwards from the central axis 109 and around a perimeter of the lock ring 108.

The lock ring 108 can interface with the base plate 102 via the snaps 112 and blocking keys 110. For example, the snaps 112 can interface with the undercut grooves 114 to secure the lock ring 108 to the base plate 102. When the lock ring 108 is interfaced with the base plate 102, the blocking keys 110 can be located adjacent to the extension members 104 to prevent rotation of the extension members 104 to lock the base plate 102 to the printing device, as is further described in connection with FIGS. 3A, 3B, and 3C.

FIG. 1B is a perspective view of an example of an apparatus 100 including a base plate 102 and a lock ring 108 interfaced with the base plate 102 consistent with the disclosure. As illustrated in FIG. 1B, the lock ring 108 is interfaced with the base plate 102. For example, the snaps 112 of the lock ring 108 can be engaged with an overhanging edge of the undercut grooves 114 of the base plate 102. Such engagement can result in a snap fit between the snaps 112 and the undercut grooves 114 to interlock the lock ring 108 with the base plate 102.

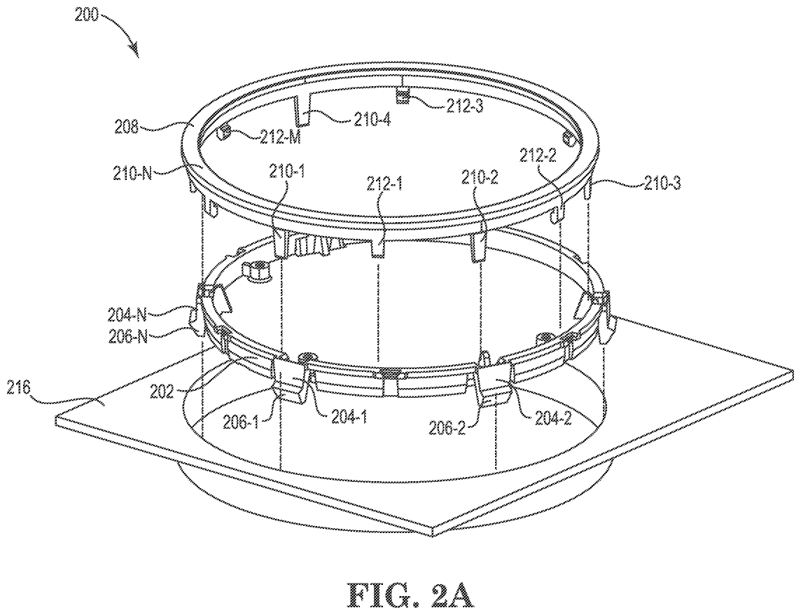

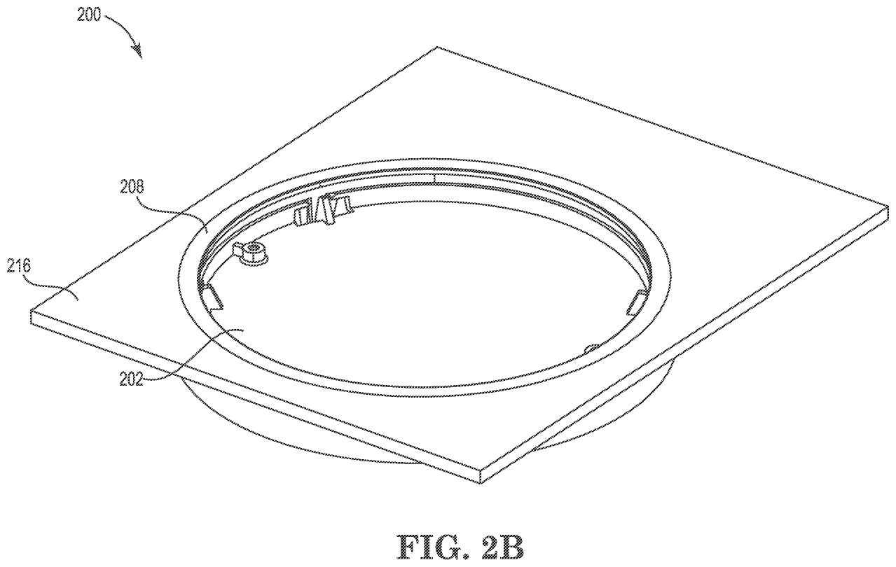

Although not illustrated in FIG. 1B, the base plate 102 can be interfaced with a cover of a printing device. Once the base plate 102 is interfaced with the cover of the printing device, the lock ring 108 can secure the base plate 102 with the cover of the printing device, as is further described in connection with FIGS. 2A and 2B.

As illustrated in FIG. 1B, the lock ring 108 can be coaxially interfaced with the base plate 102. For example, the central axis 103 of the base plate 102 can be aligned with the central axis 109 of the lock ring 108 when the lock ring 108 is secured to the base plate 102, as illustrated in FIG. 1B.

FIG. 2A is an exploded perspective view of an example of an apparatus 200 including a base plate 202, a lock ring 208, and an outer cover 216 of a printing device consistent with the disclosure. As illustrated in FIG. 2A, the base plate 202 can include extension members 204-1, 204-2, 204-N. The extension members 204-1, 204-2, 204-N can include pawls 206-1, 206-2, 206-N, respectively. The lock ring 208 can include blocking keys 210-1, 210-2, 210-3, 210-4, 210-N and snaps 212-1, 212-2, 212-3, 212-M.

As illustrated in FIG. 2A, the apparatus 200 can include an outer cover 216 of a printing device. As used herein, the term “cover” refers to an object which is located on, over, or around other object(s). For example, the outer cover 216 can be a portion of a housing of the printing device, and can be located on, over, and/or around other components of the printing device and/or the dial control panel.

The base plate 202 can interface with the outer cover 216 of the printing device. For example, the extension members 204 can interface with the outer covering via the pawls 206. Although not illustrated in FIG. 2A, the outer cover 216 of the printing device can include an undercut groove with which the pawls 206 can interface, as is further described in connection with FIG. 3B.

The apparatus 200 is illustrated in an exploded view in FIG. 2A. During manufacturing, the base plate 202 can be interfaced with the outer cover 216 via the extension members 204/pawls 206 to secure the base plate 202 to the outer cover 216. Although not illustrated in FIG. 2A, a dial control panel may be connected to the base plate 202. When the base plate 202 is interfaced with the outer cover 216, the lock ring 208 can be interfaced with the base plate 202. When the lock ring 208 is interfaced with the base plate 202, the blocking keys 210 can be located proximate to the extension members 204 to prevent the base plate 202 from disengaging from the outer cover 216 of the printing device.

FIG. 2B is a perspective view of an example of an apparatus 200 including a base plate 202, a lock ring 208 interfaced with the base plate 202, and the base plate 202 interfaced with an outer cover 216 of a printing device consistent with the disclosure. As illustrated in FIG. 2B, the base plate 202 can be interfaced with the outer cover 216 of the printing device. For example, the extension members (e.g., not illustrated in FIG. 2B) including pawls can be interfaced with an undercut groove of the outer cover 216, as is further described in connection with FIGS. 3B and 3C. Further, the snaps (e.g., not illustrated in FIG. 2B) can be interfaced with an undercut groove of the base plate 202, as is further described in connection with FIG. 3A.

FIG. 3A is a section view of an example of a printing device 320 including a base plate 302, a lock ring 308 including snaps 312, and an outer cover 316 of a printing device consistent with the disclosure. As illustrated in FIG. 3A, the lock ring 308 can be interfaced with the base plate 302 and the base plate 302 can be interfaced with the outer cover 316.

As illustrated in FIG. 3A, the lock ring 308 can include snaps 312. As previously described in connection with FIG. 1A, the snaps 312 can include a protruding flange having an engagement tooth. The engagement teeth of the snaps 312 can engage with the undercut grooves 314-1, 314-N of the base plate 302. For example, the engagement tooth of the snaps 312 can be pressed over and around the undercut grooves 314 to interlock the snaps 312 with the undercut grooves 314. The snaps 312 engaging with the undercut grooves 314 can allow the base plate 302 to interlock with the lock ring 308 via a snap fit between the snaps 312 and the undercut grooves 314. The lock ring 308 can e interlocked with the base plate 302 after the base plate is interfaced with the outer cover 316, as is further described in connection with FIGS. 3B and 3C.

FIG. 3B is a section view of an example of a printing device 320 including a base plate 302 including an extension member 304-1 having a pawl 306-1, a lock ring 308 including a blocking key 310-1, and an outer cover 316 of the printing device 320 consistent with the disclosure. As illustrated in FIG. 3B, the lock ring 308 can be interfaced with the base plate 302 and the base plate 302 can be interfaced with the outer cover 316.

As illustrated in FIG. 3B, the outer cover 316 can include undercut groove 318-1. For example, the undercut groove 318-1 can be an indentation in the surface of the outer cover 316 having an overhanging edge that can be utilized (e.g., engaged) by the pawl 306-1 to secure the base plate 302 to the outer cover 316, as is further described herein.

When the base plate 302 is oriented to interface with the outer cover 316, the extension member 304-1 can be aligned such that the pawl 306-1 is aligned with the undercut groove 318-1. When the base plate 302 is interfaced with the outer cover 316, the pawl 306-1 can engage with the undercut groove 318-1. For example, the shape of the pawl 306-1 can cause the extension member 304-1 to rotate towards the central axis 303 of the base plate 302 until the engagement tooth of the pawl 306-1 engages with the undercut groove 318-1 in the outer cover 316. Such engagement can interlock the base plate 302 with the outer cover 316 via a snap fit therebetween.

As is additionally illustrated in FIG. 3B, the lock ring 308 can be interfaced with the base plate 302. When the lock ring is interfaced with the base plate 302, the blocking key 310-1 can be located proximate to the extension member 304-1. The blocking key can prevent the base plate 302 from disengaging from the outer cover 316, as is further described herein.

For example, because of the shape of the pawl 306-1, if the base plate 302 experiences a sufficient upwards force (e.g., as oriented in FIG. 3B), the base plate 302 can be disengaged from the outer cover 316, as is further described in connection with FIG. 3C. Such disengagement may be desirable if a technician is to perform maintenance, cleaning, or repairs on the dial control panel. However, outside of such a situation, it may be desirable to prevent the base plate 302 from being disengaged from the outer cover 316.

Accordingly, the blocking key 310-1 can prevent rotation of the extension member 304-1 if the base plate experiences an upward force (e.g., relative to the outer cover 316) of the printing device 320. For example, if the base plate 302 experiences an upward force, the shape of the pawl 306-1 would allow the extension member 304-1 to rotate towards the central axis 303 to disengage the base plate 302 from the outer cover 316. However, as the blocking key 310-1 is located proximate to (e.g., adjacent to) the extension member 304-1, the blocking key prevents the extension member 304-1 from rotating such that the pawl 306-1 remains engaged with the undercut groove 318-1 of the outer cover 316. As previously described in connection with FIG. 3A, the lock ring 308 can be interlocked with the base plate 302 via the snaps. Accordingly, the base plate 302 can remain interfaced with the outer cover 316 via the lock ring 308 that is interfaced with the base plate 302.

Although the lock ring 308 is illustrated as including a single blocking key 310-1, the base plate 302 is illustrated as including a single extension member 304-1 having a pawl 306-1, and the outer cover 316 is illustrated as including a single undercut groove 318-1, examples of the disclosure are not so limited. For example, the lock ring 308 can include multiple blocking keys (e.g., N blocking keys), the base plate 302 can include multiple extension members having pawls (e.g., N extension members having N pawls), and the outer cover 316 can include multiple undercut grooves (e.g., N undercut grooves). For instance, the lock ring 308 can include three blocking keys, the base plate 302 can include three extension members each having a pawl, and the outer cover 316 can include three undercut grooves such that each blocking key can prevent rotation of each extension member where each pawl of each extension member can be interfaced with each of the undercut grooves. Additionally, the lock ring 308 can include more than three blocking keys or less than three blocking keys, the base plate 302 can include more than three extension members each having a pawl or less than three extension members each having a pawl, and the outer cover 316 can include more than three undercut grooves or less than three undercut grooves.

FIG. 3C is a zoomed section view of an example of a printing device 320 including a base plate 302 including an extension member 304-1 having a pawl 306-1, a lock ring 308 including a blocking key 310-1, and an outer cover 316 of the printing device 320 consistent with the disclosure. As illustrated in FIG. 3C, the lock ring 308 can be interfaced with the base plate 302 and the base plate 302 can be interfaced with the outer cover 316.

As illustrated in FIG. 3C, the pawl 306-1 can be angled relative to the extension member 304-1. Such an angled orientation can allow the base plate 302 to be disengaged from the outer cover 316 in response to a vertical force being applied to the base plate 302 opposite the direction of the outer cover 316 of the printing device 320 when the lock ring 308 is not interfaced with the base plate 302. As mentioned previously in FIG. 3B, such disengagement may be desirable if a technician is to perform maintenance, cleaning, or repairs on the dial control panel.

When the base plate 302 is disengaged from the outer cover 316 (e.g., when the lock ring 308 is not interfaced with the base plate 302), the extension member 304-1 can rotate, from an initial position to a deflected position, in a direction towards the central axis of the base plate 302 (e.g., to the left side, as oriented in FIG. 3C) as it is deflected by the undercut groove 318-1. Such rotation can occur until the pawl 306-1 is no longer engaged with the undercut groove 318-1 and the base plate 302 is disengaged from the outer cover 316, when the extension member 304-1 rotates back to its initial position.

When the base plate 302 is interfaced with the outer cover 316, the extension member 304-1 can again rotate, from an initial position to a deflected position, in a direction towards the central axis of the base plate 302 (e.g., to the left side, as oriented in FIG. 3C) as it is deflected by the undercut groove 318-1. Such rotation can occur until the pawl 306-1 engages with the undercut groove 318-1 and the base plate 302 is engaged with the outer cover 316, when the extension member 304-1 rotates back to its initial position.

Lock ring with blocking keys, according to the disclosure, can allow for a printing device to utilize a base plate to interface with the printing device. The base plate can allow the dial control panel to be interfaced with the printing device without the use of tools and/or mechanical fasteners. Further, the lock ring can lock the base plate to the printing device to ensure the base plate (e.g., and the dial control panel) remain locked and/or secured to the printing device during testing, shipment, and/or during use by a customer.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1A and an analogous element may be identified by reference numeral 202 in FIG. 2A. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a base plate to interface with a printing device, wherein the base plate includes an extension member having a pawl; and
a lock ring, wherein the lock ring includes a blocking key;
wherein the lock ring is to interface with the base plate such that the blocking key prevents rotation of the extension member to lock the base plate to the printing device.

2. The apparatus of claim 1, wherein the lock ring includes a snap.

3. The apparatus of claim 2, wherein the snap is to engage with an undercut groove in the base plate to interlock the lock ring with the base plate via a snap fit therebetween.

4. The apparatus of claim 1, wherein the base plate is to interface with an outer cover of the printing device.

5. The apparatus of claim 4, wherein the pawl is to engage with an undercut groove in the outer cover of the printing device to interlock the base plate with the outer cover via a snap fit therebetween.

6. The apparatus of claim 5, wherein the pawl is angled relative to the extension member such that the base plate is to disengage from the outer cover in response to a vertical force applied to the base plate opposite of the direction of the outer cover of the printing device when the lock ring is not interfaced with the base plate.

7. An apparatus, comprising:
a base plate to interface with an outer cover of a printing device, wherein the base plate includes:
an extension member having a pawl; and
a base plate undercut groove;
a lock ring to interface with the base plate, the lock ring including:
a blocking key; and
a snap to interface with the base plate undercut groove via a snap fit;
wherein when the lock ring is interfaced with the base plate, the blocking key is to be located proximate to the extension member to prevent the base plate from disengaging from the outer cover of the printing device.

8. The apparatus of claim 7, wherein the pawl is to engage with an undercut groove of the outer cover of the printing device when the base plate is interfaced with the outer cover.

9. The apparatus of claim 7, wherein in response to the base plate experiencing an upward force relative to the outer cover of the printing device, the blocking key is to prevent rotation of the extension member such that the pawl remains engaged with the undercut groove of the outer cover.

10. The apparatus of claim 7, wherein the lock ring is to coaxially interface with the base plate.

11. A printing device, comprising:
an outer cover including an undercut groove;
a base plate, including:
a plurality of extension members, each having a pawl to engage with the undercut groove of the outer cover when the base plate is interfaced with the outer cover;
a base plate undercut groove;
a lock ring, including:
a plurality of blocking keys; and
a plurality of snaps to engage with the base plate undercut groove via a snap fit when the lock ring is interfaced with the base plate;
wherein when the lock ring is interfaced with the base plate, the plurality of blocking keys are each to be located proximate to a corresponding extension member of the plurality of extension members to prevent the base plate from disengaging from the outer cover.

12. The printing device of claim 11, wherein the plurality of extension members are radially spaced apart from a central axis of the base plate.

13. The printing device of claim 12, wherein when the base plate is interfaced with the outer cover, the plurality of extension members are to rotate towards the central axis until the pawl of each of the plurality of extension members are engaged with the undercut groove of the cover.

14. The printing device of claim 11, wherein the plurality of blocking keys are radially spaced apart from a central axis of the lock ring.

15. The printing device of claim 11, wherein the plurality of snaps are radially spaced apart from a central axis of the lock ring.
